(19) United States
(12) Patent Application Publication
(10) Pub. No.: US 2009/0179719 A1
(43) Pub. Date: Jul. 16, 2009

(54) MAGNETIZING DEVICE

(76) Inventors: Li-Chain CHEN, Taoyuan Hsien (TW); Shih-Ming HUANG, Taoyuan Hsien (TW)

Correspondence Address: Muncy, Geissler, Olds & Lowe, PLLC, P.O. BOX 1364, FAIRFAX, VA, 22038-1364, US

(21) Appl. No.: 12/351,637

(22) Filed: Jan. 9, 2009

(30) Foreign Application Priority Data
Jan. 11, 2008 (CN) 200810002941.3

(51) Int. Cl. H01F 13/00

(52) U.S. Cl. 335/284

(57) ABSTRACT

A magnetizing device for magnetizing a to-be-magnetized object is disclosed. The magnetizing device includes a first magnetic-conducting element, a second magnetic-conducting element and at least a magnetic element. The magnetic element is disposed between the first magnetic-conducting element and the second magnetic-conducting element. A closed magnetic flux loop is formed between the first magnetic-conducting element, the first magnetic element and the second magnetic-conducting element so as to allow the first to-be-magnetized object to be magnetized.

### CROSS REFERENCE TO RELATED APPLICATIONS

This Non-provisional application claims priority under 35 U.S.C. §119(a) on Patent Application No(s). 200810002941.3, filed in China on Jan. 11, 2008, the entire contents of which are hereby incorporated by reference.

### BACKGROUND OF THE INVENTION

1. Field of Invention

The present invention relates to a magnetizing device, and in particular to a magnetizing device capable of magnetizing a to-be-magnetized magnetic element without electric power.

2. Related Art

Referring to FIG. 1, a conventional magnetizing device 10 has an upper magnetization seat 11 and a lower magnetization seat 12. The opposite sides of the upper and lower magnetization seats 11, 12 are formed with several parallel projecting wiring posts 111, 121. Several magnetizing plates 112, 122 extend from two sides of the top end of the wiring posts 111, 121, respectively. The wiring posts 111, 121 of the upper and lower magnetization seats 11, 12 are respectively wound with coils 113, 123 alternately. In addition, the coils 113 of the upper magnetization seat 11 and the coils 123 of the lower magnetization seat 12 have to be disposed at non-relative positions and have different polarities. Because the coil winding spaces provided at two sides of the wiring posts 111, 121 are not restricted, the number of turns of the coils 113, 123 can be increased to enhance the magnetic polarity. In addition, the structures of the upper and lower magnetization seats 11, 12 are flat, so that the magnetizing plates 112, 122 can smoothly lie on the magnet 13 and the magnetic density of the magnetized magnet 13 can be averaged. In addition, the insufficiently magnetized region generated between the magnetic pole regions can be avoided, and the generation of the induction dead spot when the motor is started can be thus avoided.

Furthermore, another kind of magnetizing device is popularly used in the current magnetizing technique, in which a magnetizer is utilized to perform the magnetization. However, this method has the following disadvantages. Firstly, the price of the magnetizer is high and the magnetizer consumes a lot of electric power. Secondly, the magnetization seat of the magnetizer generates high thermal energy at the instant of magnetization, so that the speed of its operation is low, and the high temperature also influences the magnetization and the magnetic property of the magnet. Further, a cooling system and an apparatus thereof are also additionally disposed on the magnetization seat in order to reduce the variation of magnetization. In addition, high voltage and high current are utilized during the magnetizing process for providing strong magnetization field, and thus the operator encounters increasing danger when he or she is operating.

### SUMMARY OF THE INVENTION

In view of the foregoing, the present invention is to provide a magnetizing device, which does not use a magnetizer and has the advantages of environment protecting and energy saving. The magnetizing device has a permanent magnet with two-poles or multi-poles for providing a fixed magnetic field with a intensity of magnetic field greater than or equal to 800 kA/m. Because the permanent magnet pertains to the natural energy, the magnetization field can be generated to magnetize a to-be-magnetized magnetic element without electric power and a magnetizer.

To achieve the above, the present invention discloses a magnetizing device for magnetizing a first to-be-magnetized object. The magnetizing device includes a first magnetic-conducting element, a first magnetic element and a second magnetic-conducting element. The first magnetic element is disposed between the first magnetic-conducting element and the second magnetic-conducting element, wherein a closed magnetic flux loop is formed between the first magnetic-conducting element, the first magnetic element and the second magnetic-conducting element so as to allow the first to-be-magnetized object to be magnetized. A first space is formed between the first magnetic element and the first magnetic-conducting element. The first to-be-magnetized object is disposed and magnetized in the first space, and the first to-be-magnetized object is made of a magnet material.

Further, the above-mentioned magnetizing device may include a second magnetic element disposed between the first magnetic-conducting element and the first magnetic element, and the first space is arranged between the second magnetic element and the first magnetic element.

In addition, the present invention discloses another magnetizing device for magnetizing a first to-be-magnetized object and a second to-be-magnetized object. The magnetizing device includes a first magnetic-conducting element, a second magnetic-conducting element and a first magnetic element. The first magnetic element is disposed between the first magnetic-conducting element and the second magnetic-conducting element. A first space is formed between the first magnetic element and the first magnetic-conducting element. The first to-be-magnetized object is disposed and magnetized in the first space. A second space is formed between the first magnetic element and the second magnetic-conducting element, and the second to-be-magnetized object is disposed and magnetized in the second space.

In addition, the magnetizing devices of the present invention can be applied to a machine of automation or semi-automation so as to introduce into the first to-be-magnetized object and take out after the to-be-magnetized object being magnetized and join sequential procedures of manufacturing a rotor of a fan.

### BRIEF DESCRIPTION OF THE DRAWINGS

The present invention will be fully understood from the subsequent detailed description and accompanying drawings, which are given by way of illustration only, and thus are not limitative of the present invention, and wherein:

FIG. 1 is a schematic illustration showing a conventional magnetizing device;

FIG. 2-4 are schematic illustrations showing three magnetizing device according to a first embodiment of the present invention;

FIG. 5 is a schematic illustration showing a magnetizing device according to a second embodiment of the present invention;

FIG. 6-8 A are schematic illustrations showing three magnetizing device according to a third embodiment of the present invention;

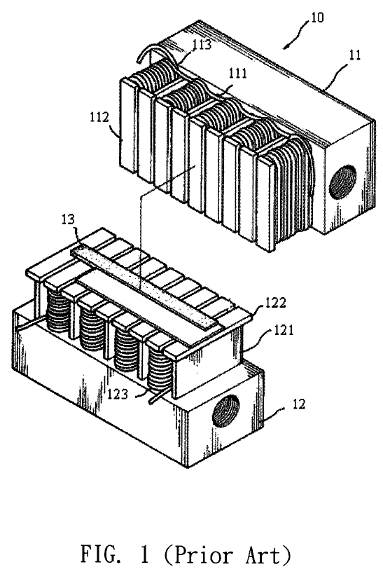

### DETAILED DESCRIPTION OF THE INVENTION

The present invention will be apparent from the following detailed description, which proceeds with reference to the accompanying drawings, wherein the same references relate to the same elements.

A magnetizing device of the present invention is for magnetizing a first to-be-magnetized object, the magnetizing device includes a first magnetic-conducting element, a second magnetic-conducting element and a first magnetic element. The first to-be-magnetized object is made of a magnetic material. The first magnetic-conducting element may be a magnetic-conducting column made of a magnetic-conducting material. The second magnetic-conducting element may be a magnetic-conducting ring made of magnetic-conducting material. The first magnetic element may be a permanent magnet with a plurality of magnetic poles. In this embodiment, the first magnetic element is a permanent magnet with four magnetic poles. The four magnetic poles are N and S poles arranged alternately. However, the arrangement of the N and S poles is not limited thereto.

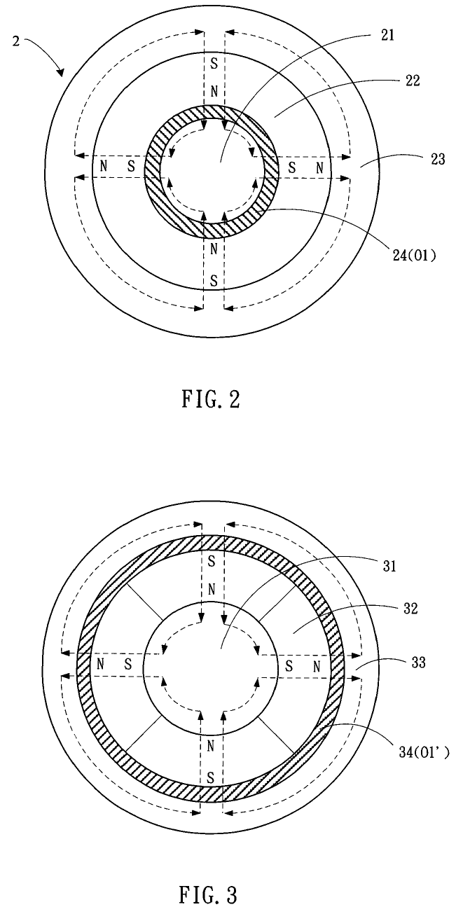

As shown in FIG. 2, a magnetizing device 2, which has an annular shape, includes a first magnetic-conducting element (e.g. a magnetic-conducting column) 21 and a first magnetic element (e.g. a permanent magnet) 22 disposed around the magnetic-conducting column 21. A first space 24 serving as a magnetizing region is formed between the permanent magnet 22 and the magnetic-conducting column 21. A second magnetic-conducting element (e.g. a magnetic-conducting ring) 23 is mounted around an outer periphery of the permanent magnet 22. A first to-be-magnetized magnet O1 is disposed in the first space 24 so that the magnetization is performed. The first to-be-magnetized magnet O1 is disposed into the first space 24 or taken out of the first space 24 along a direction perpendicular to the magnetic loop.

The magnetizing device 2 of the present invention is mainly composed of the magnetic-conducting column 21, the permanent magnet 22 and the magnetic-conducting ring 23, so that the first space 24 is formed as a closed magnetization space and field capable of magnetizing the first to-be-magnetized magnet O1. The distribution of the magnetic field of the magnetizing device 2 is shown in FIG. 2. The complete and closed magnetic flux loop having more than two poles (four poles in this embodiment) is formed by using the permanent magnet 22, which provides a fixed magnetic field, together with the magnetic-conducting materials (the magnetic-conducting column 21 and the magnetic-conducting ring 23) mounted on the circumference of the permanent magnet 22. Thereby, the permanent magnet 22 and the magnetic-conducting materials (the magnetic-conducting column 21 and the magnetic-conducting ring 23) can magnetize elements (such as the first to-be-magnetized magnet O1, the components of the first to-be-magnetized magnet O1 or other components needed to be magnetized) disposed in the closed magnetization space. The first to-be-magnetized magnet O1 is shaped according to the shape (e.g., an annular shape) and size of the magnetization space.

At the instant of magnetization, the magnetic field pass through the closed magnetic flux loop of the first space 24. So that the first to-be-magnetized magnet O1 would have four poles and sufficient magnetic force correspond to the requirement of the device or the product after the first to-be-magnetized magnet O1 is taken out from the first space 24. The above-mentioned magnetization technology can be applied to the manufacturing processes of DC fan or relevant spindle motor, so that the manufacturing cost would be reduced and the throughput would be increased. For example, the magnetized first to-be-magnetized magnet O1 may serve as the magnet ring inside the rotor of the motor for providing the magnetic force required to drive the rotor to rotate.

Please refer to FIG. 3, the difference between FIG. 3 and FIG. 2 is that the first to-be-magnetized magnet O1′ is disposed in a second space 34 between the permanent magnet 32 and the magnetic-conducting ring 33. Such a design can similarly form a closed magnetization space and field capable of magnetizing the first to-be-magnetized magnet O1′. Therefore, at the instant of magnetization, the magnetic field pass through the closed magnetic flux loop of the second space 34, so that the first to-be-magnetized magnet O1′ is simultaneously magnetized to have two or multiple poles and sufficient magnetic force correspond to the requirement of the device or the product.

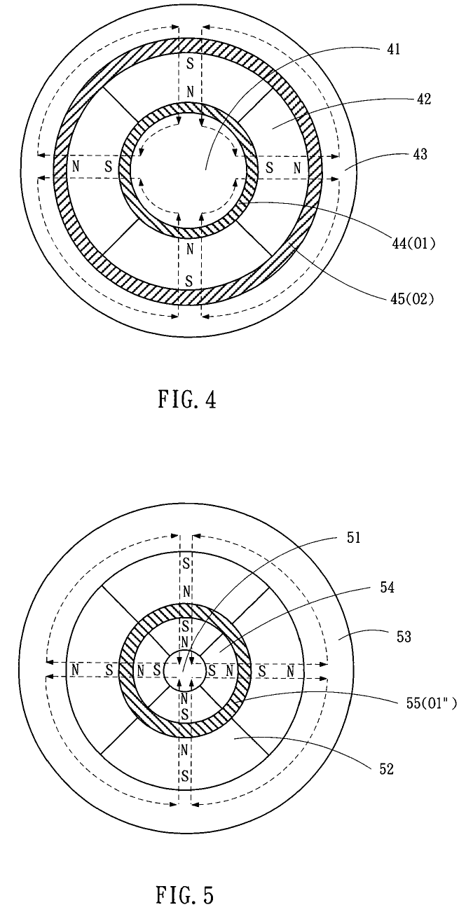

Please refer to FIG. 4, the difference between FIG. 4 and FIG. 2 is that except the existence of the first space 44, there is further a second space 45 formed between the permanent magnet 42 and the magnetic-conducting ring 43, and a second to-be-magnetized magnet O2 is disposed in the second space 45. Therefore, at the instant of magnetization, the magnetic field pass through the closed magnetic flux loop of the first space 44 and the second space 45, so that the first to-be-magnetized magnet O1 and the second to-be-magnetized magnet O2 are simultaneously magnetized to have two or multiple poles and sufficient magnetic force.

Further, except the above-mentioned structure, the magnetizing device can have more than one magnetic element. Compared with the magnetizing devices of FIG. 2 and FIG. 3, the magnetizing device of FIG. 5 further includes a second magnetic element 54. In FIG. 5, the second magnetic element 54 is mounted around the outer periphery of a magnetic-conducting column 51, and a first magnetic element 52 is disposed around the second magnetic element 54. Similar to the first magnetic element 52, the second magnetic element 54 is a permanent magnet having a plurality of magnetic poles, such as four magnetic poles. The four magnetic poles of the permanent magnet are N and S poles arranged alternately. However, the arrangement of the N and S poles is not limited thereto.

The N pole of the permanent magnet 52 faces the S pole of the permanent magnet 54, and the S pole of the permanent magnet 52 faces the N pole of the permanent magnet 354 so that a closed magnetization space and field capable (the first space 55) of magnetizing a magnet is formed. Therefore, the magnetic-conducting column 51 and the magnetic-conducting ring 53 cooperate with the magnetic fields formed by the first magnetic element 52 and the second magnetic element 54 for magnetizing the to-be-magnetized magnet O1″, the components of the to-be-magnetized magnet O1″ or other components needed to be magnetized in the first space 55 (magnetizing region). At the instant of magnetization, the magnetic field pass through the closed magnetic flux loop of the first space 55. So that the to-be-magnetized magnet O1″ would have four poles and sufficient magnetic force correspond to the requirement of the device or the product after the magnetization.

Comparing with the magnetizing method using only one permanent magnet, the magnetizing effect on the to-be-magnetized magnet O1″ performed by the first magnetic element 52 and the second magnetic element 54 is better than the magnetizing effect on the to-be-magnetized magnet O1 or the to-be-magnetized magnet O1′ performed by the single permanent magnet 22 or the single permanent magnet 32, and the magnetizing process performed by the two permanent magnets is also quicker than the magnetizing process performed by only one permanent magnet.

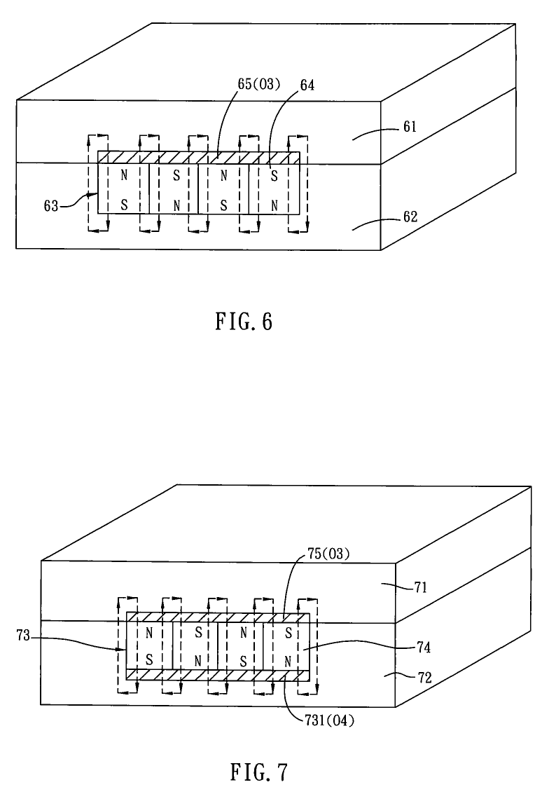

It is noted that the present invention is not limited to the above-mentioned embodiments. For example, the magnetizing devices of FIGS. 2-4 can be modified by using the design of FIG. 5. Also, the magnetizing devices in FIGS. 2-5 are in an annular shape, and all components are arranged radially or have an inner-outer ring relationship, but the magnetizing device can be another shape and its components may be arranged in different location relationship. For example, referring to FIG. 6, the magnetizing device has a flat and rectangular shape and includes a first magnetic-conducting element 61 and a second magnetic-conducting element 62, both of which are stacked together and can be separated easily for taking out a to-be-magnetized magnet there between after finishing the magnetizing process. Both of the first magnetic-conducting element and the second magnetic-conducting element are magnetic-conducting blocks, and the first magnetic-conducting element and the second magnetic-conducting element are coupled to each other correspondingly.

The second magnetic-conducting element 62 is dug with a slot 63 for accommodating a first magnetic element 64, and a first space 65 serving as a magnetizing region is formed between the first magnetic element 64 and the first magnetic-conducting element 61, wherein a first to-be-magnetized magnet O3 can be disposed into the first space 65 so that a closed magnetic flux loop is formed between the first magnetic-conducting element 61, the second magnetic-conducting element 62 and the first magnetic element 64, and the magnetization is performed.

Also, similar to the concept disclosed in FIG. 4, as long as the to-be-magnetized magnet is passed by the magnetic flux, it is not limited to set only one accommodating space for placing a to-be-magnetized magnet. Please referring to FIG. 7, the magnetizing device 7 has a first space 75 and a second space 731 for respectively accommodating a first to-be-magnetized magnet O3 and a second to-be-magnetized magnet O4. The first space 75 is formed between the first magnetic-conducting element 71 and the first magnetic element 74; the second space 731 is formed between the first magnetic element 74 and the second magnetic-conducting element 72.

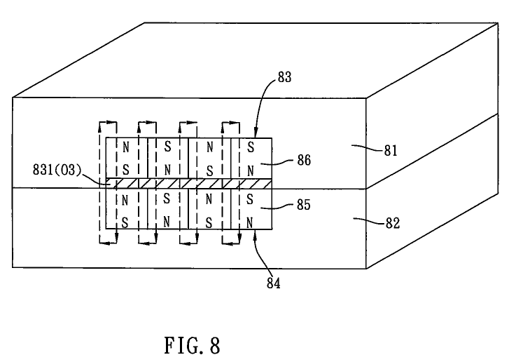

Further, similar to the concept disclosed in FIG. 5, the magnetizing device may have more than two permanent magnets for providing magnetic forces. Referring to FIG. 8, a first slot 83 and a second slot 84 are dug in a first magnetic-conducting element 81 and a second magnetic-conducting element 82 respectively for accommodating the second magnetic element 86 and the first magnetic element 85, respectively. A first space 831 serving as a magnetizing region is formed between the first magnetic element 85, the second magnetic element 86, the first magnetic-conducting element 81 and the second magnetic-conducting element 82. A to-be-magnetized magnet O3 is disposed in the first space 831 so that the magnetization is performed.

Certainly, although the magnetizing devices in FIGS. 6-8 are rectangular and flat. However, the shape of the magnetizing device of the present invention is not limited thereto; the shape of the magnetizing device of the present invention could also be a cylinder or any other shape. Furthermore, the magnetizing device of the present invention can be applied with a machine of automation or semi-automation so as to introduce into the to-be-magnetized object and take out after the to-be-magnetized object being magnetized and join sequential procedures of manufacturing a rotor of a fan.

In summary, the magnetizing device of the present invention has at least one two-pole permanent magnet or multiple-pole permanent magnets for providing fixed magnetic field, and the intensity of the magnetic field is greater than or equal to 800 kA/m. Because the magnetic field produced by the permanent magnet pertains to the natural energy, which is inexhaustible in supply and always available for use, the magnetization field can be generated and the to-be-magnetized magnet or its components can be magnetized without electric power and magnetizer. Furthermore, it is unnecessary to use a magnetizer in the present invention, so the manufacturing cost is reduced, the time of designing and developing the product is shortened. Also, the product can be manufactured easily, environment protecting and energy saving are achieved, and the operating safety is ensured. In addition, because it is unnecessary to use a magnetizer in the invention, the step of cooling the magnetic-conducting element is unnecessary. Thus, the magnetization cycle time is fast and the magnetization quality is stable.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A magnetizing device for magnetizing a first to-be-magnetized object, the magnetizing device comprising:
a first magnetic-conducting element;
a second magnetic-conducting element; and
a first magnetic element comprising a fixed magnetic field, the first magnetic element being disposed between the first magnetic-conducting element and the second magnetic-conducting element;
wherein a closed magnetic flux loop is formed between the first magnetic-conducting element, the first magnetic element and the second magnetic-conducting element so as to allow the first to-be-magnetized object to be magnetized.

2. The magnetizing device according to claim 1, wherein a first space is formed between the first magnetic-conducting element and the first magnetic element, and the first to-be-magnetized object is disposed and magnetized in the first space.

3. The magnetizing device according to claim 2, wherein the magnetizing device further comprises a second magnetic element disposed between the first magnetic-conducting element and the first magnetic element, and the first space is disposed between the second magnetic element and the first magnetic element.

4. The magnetizing device according to claim 2, wherein the magnetizing device is further for magnetizing a second to-be-magnetized object, and a second space is formed between the first magnetic element and the second magnetic-conducting element, and the second to-be-magnetized object is disposed and magnetized in the second space.

5. The magnetizing device according to claim 4, wherein the first to-be-magnetized object, the second to-be-magnetized object, the first magnetic-conducting element and the second magnetic-conducting element comprise magnetic-conducting materials; the first magnetic element is a permanent magne.

6. The magnetizing device according to claim 4, wherein the magnetizing device further comprises a second magnetic element disposed between the first magnetic-conducting element and the first magnetic element, and the first space is disposed between the second magnetic element and the first magnetic element.

7. The magnetizing device according to claim 1, wherein a second space is formed between the first magnetic element and the second magnetic-conducting element, and the first to-be-magnetized object is disposed and magnetized in the second space.

8. The magnetizing device according to claim 1, wherein the magnetizing device has an annular shape, the first magnetic element is disposed around an exterior of the first magnetic-conducting element, and the second magnetic-conducting element is further disposed around an exterior of the first magnetic element.

9. The magnetizing device according to claim 8, wherein the first magnetic-conducting element is a magnetic-conducting column, and the second magnetic-conducting element is a magnetic-conducting ring.

10. The magnetizing device according to claim 1, wherein the magnetizing device has a flat and rectangular shape, the first magnetic-conducting element and the second magnetic-conducting element are stacked together, and the first magnetic element is disposed on the second magnetic-conducting element and between the first magnetic-conducting element and the second magnetic-conducting element.

11. The magnetizing device according to claim 10, wherein the first magnetic-conducting element and the second magnetic-conducting element are separated easily for taking out the first to-be-magnetized magnet there between after finishing a magnetizing process.

12. The magnetizing device according to claim 10, wherein both of the first magnetic-conducting element and the second magnetic-conducting element are magnetic-conducting blocks, and the first magnetic-conducting element and the second magnetic-conducting element are coupled to each other correspondingly.

13. The magnetizing device according to claim 1, wherein the closed magnetic flux loop comprises at least two poles.

14. The magnetizing device according to claim 1, wherein the first magnetic-conducting element and the second magnetic-conducting element comprise magnetic-conducting materials.

15. The magnetizing device according to claim 1, wherein the first to-be-magnetized object comprises a magnetic material.

16. The magnetizing device according to claim 1, wherein a shape and size of the first space is designed to according to the first to-be-magnetized object.

17. The magnetizing device according to claim 1, wherein the first magnetic element is a permanent magnet with a plurality of magnetic poles and the magnetic poles are N and S poles arranged alternately.

18. The magnetizing device according to claim 1, wherein the first magnetic element has a fixed magnetic field, and the intensity of the magnetic field is greater than or equal to 800 kA/m.

19. The magnetizing device according to claim 1, wherein the magnetizing device is applied to a machine of automation or semi-automation so as to introduce into the first to-be-magnetized object and take out after the to-be-magnetized object being magnetized and join sequential procedures of manufacturing a rotor of a fan.
